(19) United States
(12) Patent Application Publication
(10) Pub. No.: US 2025/0007162 A1
(43) Pub. Date: Jan. 2, 2025

(54) Electronic Devices

(71) Applicant: Anhui Huami Information Technology Co., Ltd., Hefei (CN)

(72) Inventor: Anping Zhao, Hefei (CN)

(21) Appl. No.: 18/883,370

(22) Filed: Sep. 12, 2024

Related U.S. Application Data
(63) Continuation of application No. PCT/CN2022/083357, filed on Mar. 28, 2022.

(51) Int. Cl. H01Q 5/328; H01Q 1/27; H01Q 1/36; H01Q 1/48; H01Q 7/00

(52) U.S. Cl. CPC H01Q 5/328; H01Q 1/36; H01Q 1/48; H01Q 7/00; H01Q 1/273

(57) ABSTRACT

Provided is an electronic device including: an annular conductor, a main board surrounded by the annular conductor; a dual-band grounding unit, including a first grounding unit and a second grounding unit, where the first grounding unit, the main board and the annular conductor form a circularly polarized antenna operating at a first frequency band, and the second grounding unit, the main board and the annular conductor form a circularly polarized antenna operating at the second frequency band; and a filter unit, provided in the circuit connecting the first grounding unit and/or the second grounding unit to the annular conductor, where the filter unit is configured to filter out signals at frequency bands other than a frequency band of an antenna circuit where the filter unit located.

### CROSS-REFERENCE TO RELATED APPLICATION(S)

This application is a continuation of International Application No. PCT/CN2022/083357, filed on Mar. 28, 2022, the entire disclosure of which is hereby incorporated by reference.

### TECHNICAL FIELD

The present disclosure relates to the technical field of smart devices, and more specifically, to electronic devices.

### BACKGROUND

With the development of electronic devices, satellite positioning has become one of the primary functions of the electronic devices. In order to achieve the purpose of satellite positioning, satellite positioning antennas are often indispensable for electronic devices.

In related technologies, electronic devices are often limited by their sizes and industrial designs, making it difficult to implement antenna designs, especially when there is only one annular conductor.

### SUMMARY

In order to develop a dual-band circularly polarized antenna system for electronic devices, according to an first aspect of implementations of the present disclosure, an electronic device is provided, including: an annular conductor and a main board, which are electrically connected via a grounding unit containing an inductor or a capacitor; a dual-band grounding unit, including a first grounding unit and a second grounding unit, where the first grounding unit, the main board and the annular conductor form a circularly polarized antenna operating at a first frequency band, and the second grounding unit, the main board and the annular conductor form a circularly polarized antenna operating at the second frequency band; and a filter unit is provided on a circuit connecting the first grounding unit and/or the second grounding unit to the annular conductor, where the filter unit is configured to filter out signals at frequency bands other than a frequency band of the circuit where the filter unit is located.

A second aspect of the implementations of the present disclosure provides a dual-band antenna assembly for an electronic device, comprising: a first antenna operating at a first frequency band, comprising an annular conductor, a first grounding unit and a main board; and a second antenna operating at a second frequency band, comprising at least a part of the annular conductor, a second grounding unit and the main board; wherein at least one of the first antenna or the second antenna further comprises a filter unit, the filter unit in the first antenna is configured to filter out signals at the second frequency band, and the filter unit in the second antenna is configured to filter out signals at the first frequency band; and wherein the first antenna is circularly polarized.

### BRIEF DESCRIPTION OF THE DRAWINGS

In order to more clearly explain the specific implementations of the present disclosure or the technical solutions of related technologies, a brief introduction is given below to the drawings that need to be used in the description of the specific implementations or the related technologies. Obviously, the drawings in the following description illustrate some implementation examples of the present disclosure. For those of ordinary skill in the art, other drawings can be obtained based on these drawings without making creative efforts.

FIG. 1 is a schematic diagram of a structure of an electronic device according to some implementations of the present disclosure.

FIG. 2 is a schematic diagram of a circuit of an antenna system of the electronic device according to some implementations of the present disclosure.

FIG. 3 is a schematic diagram of a circuit of a filter unit according to some implementations of the present disclosure.

FIG. 4 is another schematic diagram of the circuit of the antenna system of the electronic device according to some implementations of the present disclosure.

FIG. 5 is another schematic diagram of the circuit of the antenna system of the electronic device according to some implementations of the present disclosure.

FIG. 6 is a graph of axial ratio curves of separately designed GPS L1 frequency band and GPS L5 frequency band in the antenna system according to some implementations of the present disclosure.

FIG. 7 is a graph of axial ratio curves of the antenna system according to some implementations of the present disclosure.

FIG. 8 is another schematic diagram of the structure of the electronic device according to some implementations of the present disclosure.

FIG. 9 is another schematic diagram of the circuit of the antenna system of the electronic device according to some implementations of the present disclosure.

FIG. 10 is another schematic diagram of the circuit of the antenna system of the electronic device according to some implementations of the present disclosure.

FIG. 11 is another schematic diagram of the circuit of the antenna system of the electronic device according to some implementations of the present disclosure.

FIG. 12 is a graph of S-parameter curves of the antenna system according to some implementations of the present disclosure.

FIG. 13 is another graph of the axial ratio curves of the antenna system according to some implementations of the present disclosure.

FIG. 14 is a graph of total efficiency variation curves of the antenna system according to some implementations of the present disclosure.

FIG. 15 is another schematic diagram of the structure of the electronic device according to some implementations of the present disclosure.

FIG. 16 is another schematic diagram of the circuit of the antenna system of the electronic device according to some implementations of the present disclosure.

FIG. 17 is another graph of the S-parameter curves of the antenna system according to some implementations of the present disclosure.

FIG. 18 is another graph of the axial ratio variation curves of the antenna system according to some implementations of the present disclosure.

FIG. 19 is another graph of the total efficiency variation curves of the antenna system according to some implementations of the present disclosure.

FIG. 20 is another schematic diagram of the circuit of the antenna system of the electronic device according to some implementations of the present disclosure.

FIG. 21 is another schematic diagram of the circuit of the antenna system of the electronic device according to some implementations of the present disclosure.

### DETAILED DESCRIPTION

The technical solutions of the present disclosure will be described clearly and completely below with reference to the accompanying drawings. Obviously, the described implementations are only a part, but not all, of the implementations of the present disclosure. Based on the implementations described in the present disclosure, other implementations can be obtained by those of ordinary skill in the art without making creative efforts and fall within the protection scope of the present disclosure. In addition, the technical features involved in different implementations of the present disclosure described below can be combined arbitrarily as long as they do not conflict with each other.

Satellite positioning and motion trajectory recording have become an important function of smart electronic devices. In order to achieve the purpose of positioning and trajectory recording, satellite positioning antenna is often an indispensable structure for electronic devices. Taking the GPS satellite positioning system as an example, the civilian frequency bands of the GPS satellite positioning system include, for example, the L1 frequency band and the L5 frequency band. The central operating frequency of the L1 frequency band is approximately 1.575 GHz, and the central operating frequency of the L5 frequency band is approximately 1.176 GHz. The L1 frequency band has a larger satellite coverage, and single-band GPS antennas often support the L1 frequency band. A dual-band GPS antenna supports both L1 and L5 frequency bands, with the L1 frequency band serving as the primary frequency band, and the L5 frequency band serving as an auxiliary for the L1 frequency band, which can eliminate ionospheric errors and greatly improve positioning accuracy.

In addition, in order to enhance the signal transmission efficiency from satellites to the ground devices, such as increasing penetration capabilities and improving coverage area, circular polarization is often used for GPS transmission antennas from the satellites to the ground devices. This is because circularly polarized waves generated by the circularly polarized antennas can be received by linearly polarized antennas in any direction. Meanwhile, the circularly polarized antennas can also receive any linearly polarized incoming waves and thus has a good antenna performance. In the case of comparable antenna efficiency, there is about a 3 dB boost in strength of satellite signals received by ground devices with a circularly polarized antenna compared to a linearly polarized antenna. Therefore, compared to the GPS linearly polarized antennas, the GPS circularly polarized antennas have a better resistance to ionospheric interference and a stronger resistance to multi-path interference, which in turn can obtain more accurate information about positioning and motion trajectories.

Based on the above, it can be seen that the use of GPS dual-band circularly polarized antennas supporting both L1 and L5 frequency bands can achieve a higher accuracy in satellite positioning. However, as electronic devices continue to evolve towards miniaturization and thinness, it is often difficult to implement the dual-band circularly polarized antennas in electronic devices due to limitations in volume and industrial design, and the problem can be even more prominent especially for miniaturized devices such as wearable devices.

For instance, a GPS dual-band circularly polarized antenna can be implemented in wearable devices such as smart watches, and the dual-band circularly polarized antenna can be implemented using two conductive annular conductors positioned in the upper and lower part of the wearable device, respectively. The two circularly polarized antennas have independent antenna structures. However, in some application scenarios, electronic devices often do not have the design space for two circular shaped conductors. Taking smart watches as an example, some smart watches often include only one circular shaped metal structure, such as a metallic middle frame, which can serve as a radiator, making it difficult to implement the structural design of two circular shaped radiators. In addition, when circularly polarized antennas are provided close to the wearers' arms, the impact of the human body on the antenna performance cannot be overlooked, making it even more difficult to design. Also, a dual-band circularly polarized antenna has a relatively complex structure, which makes it difficult to design.

In order to solve the above problems, the present disclosure aims to simplify the structure of a dual-band circularly polarized antenna implemented in an electronic device, therefore reducing the complexity and difficulty associated with its design.

Before describing the electronic device according to implementations of the present disclosure, characteristics of the circularly polarized antenna is briefly described below to facilitate understanding of the implementations of the present disclosure.

For example, circular polarization can be achieved by feeding a rotating current directly into an annular conductor, and the rotation direction (left-hand or right-hand) of the circularly polarized antenna can be adjusted by using one or more capacitors and/or inductors at different locations for grounding. Considering the transmission antenna of the satellite positioning antenna is in the form of right-hand circular polarization, according to implementations of the present disclosure, unless otherwise specified, the circularly polarized antenna is described as a right-hand circularly polarized antenna. However, it can be understood that the rotation direction of the circularly polarized antenna is not limited in the implementations of the present disclosure.

Secondly, the resonant frequency of the circularly polarized antenna can be adjusted by using one or more capacitors and/or inductors at different positions of the annular conductor for grounding the circularly polarized antenna, where the use of an inductor for grounding is equivalent to shortening the effective circumference of the annular conductor, and the resonant frequency of the antenna increases compared to its original resonant frequency; and the use of a capacitor for grounding is equivalent to lengthening the effective circumference of the annular conductor, and the resonant frequency of the antenna decreases compared to its original resonant frequency.

For instance, in the case where the effective circumference of the annular conductor is fixed, for a circularly polarized antenna system, if a direct grounding scheme is adopted, the resonant frequency of the antenna is 1.46 GHz, that is, the original resonant frequency of the antenna is 1.46 GHz. If a scheme using one or more inductors for grounding is adopted for the grounding terminal of the circularly polarized antenna system, the resonant frequency of the antenna increases to 1.575 GHz for instance. If a scheme using one or more capacitors for grounding is adopted for the grounding terminal of the circularly polarized antenna system, the resonant frequency of the antenna decreases to 1.176 GHz for instance. All references cited and discussed in the present disclosure are incorporated herein by reference in their entireties.

Furthermore, two annular conductors on electronic devices can be used to realize a circularly polarized antenna with two different frequency bands. For instance, one of the annular conductors forms an antenna of the GPS L1 band, and the other annular conductor forms an antenna of the GPS L5 band, thereby forming a dual-band circularly polarized antenna. In this scheme, an annular conductor is used to realize a circularly polarized antenna with only one frequency band. It is difficult to realize dual-band circular polarization with the same annular conductor.

According to implementations of the present disclosure, the same annular conductor in the electronic device can be used to implement a dual-band circularly polarized antenna, thereby simplifying the structure of the dual-band circularly polarized antenna and facilitating its use in miniaturized wearable devices.

In some implementations, the electronic device of the present disclosure includes an annular conductor, a dual-band grounding unit, and a filter unit.

In the implementations of the present disclosure, the annular conductor is electrically connected to the main board to form a circularly polarized antenna. In particular, an annular conductor can form a circularly polarized antenna under the condition of feeding the annular conductor directly, so that rotating current is generated to form circular polarization. Also, the effective circumference of the annular conductor is equal to about the wavelength corresponding to the resonant frequency produced.

It is worth noting that the term “effective circumference of the conductor” mentioned in the present disclosure is not limited to a physical perimeter of the conductor. In free space, the physical circumference of a conductor is the effective circumference of the conductor. However, in the assembly structure, other materials around the conductor, such as the screen and the plastic back cover, can cause the effective electrical length of the conductor to increase, which makes the effective perimeter of the conductor larger than that in free space. This can be understood by those skilled in the art and will not be repeated in the present disclosure.

In some implementations, the electronic device includes a main board. The annular conductor is disposed at the periphery of the main board and surrounds the main board, and an annular gap forms between the annular conductor and the main board. The feeding unit spans the gap, where one end of the feeding unit is connected to the radio frequency unit of the main board, and the other end of the feeding unit is connected to the annular conductor, and meanwhile, the grounding unit includes a tuning element such as an inductor or a capacitor, so as to feed the annular conductor to generate a rotating current and produce a circularly polarized resonant frequency. It can be understood from the foregoing that, in the cases where no capacitor or inductor is provided for grounding, the resonance wavelength generated by the annular conductor is equal to the effective perimeter of the annular conductor. According to implementations of the present disclosure, the circularly polarized resonant frequency generated by the annular conductor without using any capacitor or inductor for grounding is defined as the original resonant frequency of the annular conductor.

It can be understood that, in some implementations of the present disclosure, the above-mentioned circularly polarized resonant frequency generated by the annular conductor includes only one frequency band, and the center frequency of the frequency band is the above-mentioned original resonant frequency.

On the basis of the above-mentioned realization of circularly polarized resonance, in the implementations of the present disclosure, a dual-band grounding unit is provided to ground the conductor. For electronic devices, the ground of the electrical system is on the main board. That is, in the implementations of the present disclosure, the dual-band grounding unit is provided to electrically connect the annular conductor to the ground of the main board. The main board further includes a radio frequency unit, and the annular conductor may be electrically connected to the radio frequency unit of the main board via one or more feeding terminals.

In some implementations, the dual-band grounding unit includes a first grounding unit and a second grounding unit. It can be seen that, for a circularly polarized antenna, the resonant frequency of the antenna can be adjusted by providing one or more capacitors and/or inductors for grounding. Specifically, utilizing a capacitor for grounding can reduce the resonant frequency of the antenna, and utilizing an inductor for grounding can increase the resonant frequency of the antenna.

Therefore, in the implementations of the present disclosure, the first grounding unit and the second grounding unit may include one or more grounding terminals, and the grounding terminals are electrically connected to one or more capacitors and/or inductors. In the case where the annular conductor is electrically connected to the main board via the first grounding unit, the operation frequency band of the circularly polarized antenna is a first frequency band. In the case where the annular conductor is electrically connected to the main board via the second grounding unit, the operation frequency band of the circularly polarized antenna is a second frequency band.

For instance, the first grounding unit and the annular conductor form a circularly polarized antenna with an operating frequency band of GPS L1, which has a center frequency of 1.575 GHz, while the second grounding unit and the annular conductor form a circularly polarized antenna with an operating frequency band of GPS L5, which has a center frequency of 1.176 GHz. The GPS L1 frequency band is taken as the first frequency band, and the GPS L5 frequency band is taken as the second frequency band.

However, it can be understood that, if both the first grounding unit and the second grounding unit are simultaneously applied to the same annular conductor, the two grounding units affect each other, causing neither of the first frequency band and the second frequency band is generated.

Therefore, in the implementations of the present disclosure, a filter unit is configured to isolate the first frequency band and the second frequency band. The filter unit is configured to filter out the signals with a frequency band other than the frequency band of the antenna circuit to which the filter unit belongs, so as to enable the first frequency band to be invisible to the antenna circuit that generates the second frequency band, and enable the second frequency band to be invisible to the antenna circuit that generates the first frequency band. In this way, the first frequency band and the second frequency band do not interfere with each other, thereby realizing dual-band circular polarization.

Specifically, the filter unit may include a first filter unit provided on a circuit connecting the first grounding unit to the annular conductor, and/or a second filter unit provided on a circuit connecting the second grounding unit to the annular conductor.

In an example, the filter unit includes a first filter unit and a second filter unit. It can be understood that, in the case where only the first grounding unit is present in the circularly polarized antenna, the antenna circuit including the first grounding unit, the annular conductor and the main board generates circularly polarized waves only at the first frequency band. In the case where only the second grounding unit is present in the circularly polarized antenna, the antenna circuit including the second grounding unit, the annular conductor and the main board generates circularly polarized waves only at the second frequency band.

Therefore, in some examples, the first filter unit is provided on the circuit connecting the first grounding unit and the annular conductor. The first filter unit filters out signals at frequency bands other than the first frequency band, so that the second frequency band does not interfere with the antenna circuit where the first grounding unit is located, achieving circular polarization at the first frequency band. Meanwhile, the second filter unit is provided on the circuit connecting the second grounding unit to the annular conductor. The second filter unit filters out signals at frequency bands other than the second frequency band, so that the first frequency band does not affect the antenna circuit where the second grounding unit is located, and circular polarization at the second frequency band is realized. Therefore, the same conductor is utilized to achieve dual-band circular polarization at the first frequency band and the second frequency band.

It is worth noting that, in the implementations of the present disclosure, the filter unit may be provided only in the circuit where the first grounding unit is connected to the annular conductor; or, the filter unit may be provided only in the circuit where the second grounding unit is connected to the annular conductor. Alternatively, the first filter unit is provided in the circuit connecting the first grounding unit and the annular conductor, and the second filter unit is provided in the circuit connecting the second grounding unit and the annular conductor. Each of the above implementations can realize the dual-band circular polarization solution of the present disclosure, and will be specifically described in the following.

In some implementations, the filter unit may include any one or a combination of at least one selected from a group including band-stop filters, band-pass filters, high-pass filters and low-pass filters, as long as the filter unit can filter out signals at frequency bands other than the frequency band of the antenna circuit where the filter unit is located, and the present disclosure does not set limitations on the implementations of the filter unit.

As can be seen from the above, in the implementations of the present disclosure, a dual-band circularly polarized antenna for electronic devices can be realized, and the antenna performance can be improved. The disclosed solution for realizing the dual-band GPS circularly polarized antenna can greatly improve the positioning accuracy and trajectory accuracy of the device. Moreover, in the implementations of the present disclosure, the dual-band circularly polarized antenna is realized by using only one conductor, which simplifies the antenna structure, is especially beneficial for use in miniaturized wearable devices such as wrist-worn devices, and reduces the difficulty of antenna design.

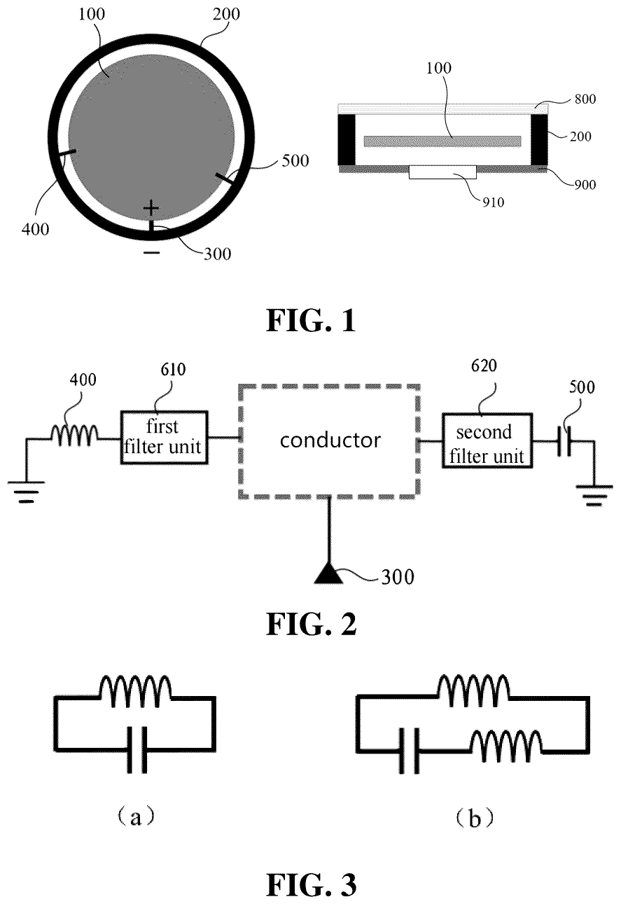

FIG. 1 shows the electronic device with the dual-band circularly polarized antenna in some implementations.

It can be understood that, the dual-band circularly polarized antenna described in the implementations of the present disclosure can realize circularly polarized antennas operating at any two different frequency bands, that is, the specific frequency values of the “first frequency band” and the “second frequency band” in the present disclosure is not limited to the examples given in the description. Based on the implementations of the present disclosure, those skilled in the art can realize the design of dual-band circularly polarized antennas operating at various desired frequency bands according to specific needs.

In the following implementations of the present disclosure, the dual-band GPS circularly polarized antenna for electronic devices is described by taking the first frequency band including the GPS L1 frequency band and the second frequency band including the GPS L5 frequency band as an example. In other examples, the first frequency band may include the GPS L5 frequency band and the second frequency band include the GPS L1 frequency band. In other examples, the first frequency band and the second frequency band may be other frequency bands for short-distance or long-distance communication, which is not limited in the present disclosure.

As shown in FIG. 1, in some implementations, the electronic device of the present disclosure includes a main board 100 and an annular conductor 200. The annular conductor 200 is arranged around the periphery of the main board 100, and an annular gap structure is formed between the annular conductor 200 and the main board 100.

In an example, the electronic device is exemplified as a smart watch. The main board 100 may be a printed circuit board (PCB) of the smart watch, and the annular conductor 200 may be a conductive middle frame of the smart watch. A screen assembly 800 is attached to an upper side of the annular conductor 200, and the non-metallic (such as plastic) back cover is attached to a lower side of the annular conductor 200. In some implementations, a heart rate protuberance structure 910 is provided in the center region of the back cover 900, so that a heart rate sensor of the electronic device is able to detect human physiological parameters through the heart rate protuberance structure 910. It can be understood that, the smart watch may further include other structures and electrical components, which will not be described in detail in the present disclosure.

The feeding unit 300 is connected across the annular gap between the main board 100 and the annular conductor 200. One end of the feeding unit 300 is connected to the annular conductor 200, and the other end of the feeding unit 300 is electrically connected to a radio frequency unit of the main board 100. The radio frequency unit directly feeds the annular conductor 200 through the feeding unit 300, and is connected to the ground via one or more inductors and/or capacitors, which can cause the annular conductor 200 to generate a rotating circular current, and the annular conductor 200 can radiate circularly polarized resonant waves to the outside, so as to achieve single-band circular polarization, and a wavelength of the generated circularly polarized resonance is equal to the effective circumference of the annular conductor 200.

In some implementations, the dual-band grounding unit includes a first grounding unit 400 and a second grounding unit 500. On the basis of realizing a circularly polarized antenna, the resonance frequency of the circularly polarized antenna can be adjusted without changing the rotation direction of the circularly polarized antenna by providing one or more capacitors and/or inductors at appropriate locations for grounding. Accordingly, the grounding unit includes one or more inductors and/or one or more capacitors.

In some examples, to realize the dual-band GPS circular polarization, as shown in FIG. 1, it is assumed that an original resonance frequency of the circular antenna is 1.46 GHz in the case that the first grounding unit 400 and the second grounding unit 500 are not present.

In order to realize the GPS L1 frequency band, the first grounding unit includes an inductor for grounding, so as to increase the resonant frequency of the circular antenna. The inductance value and/or position of the inductor may be adjusted for instance, so as to adjust the resonant frequency of the circularly polarized antenna to the desired GPS L1 frequency band centered at 1.575 GHz.

In addition, in order to realize the GPS L5 frequency band, the second grounding unit may include a capacitor for grounding, so as to reduce the resonant frequency of the antenna. The inductance value and/or position of the capacitor may be adjusted for instance, so as to adjust the resonant frequency of the circularly polarized antenna to the desired GPS L5 frequency band centered at 1.176 GHz.

In the case where circular polarization at two frequency bands is implemented by using the dual-band grounding unit, the filter unit is configured to isolate the two antenna circuits, so as to avoid the two frequency bands affecting each other.

FIG. 2 illustrates an example circuit of the dual-band circularly polarized antenna shown in FIG. 1. In this example, the first antenna operating at the first frequency band and the antenna operating at the second frequency band share the feeding unit 300, and both of them include a filter unit and a tuning component. The filter unit is configured to isolating signals at the first frequency band and the second frequency band. The tuning component is configured to pull the current generated by the annular conductor to form a circulating current being rotated. In some examples, the tuning component includes one or more inductors and/or one or more capacitors, but is not limited thereto.

As shown in FIG. 2, in some implementations, the annular conductor 200, the feeding unit 300, and the first grounding unit 400 are configured to generate circulating current signals at the first frequency band, and a first filter unit 610 is provided on an antenna circuit connecting the first grounding unit 400 to the annular conductor 200. The first filter unit 610 is configured to allow current signals at the first frequency band to pass through, and prevent current signals at the second frequency band from passing through. For instance, in the above examples, the first filter unit 610 is configured to prevent current signals at the GPS L5 frequency band from passing through and allow current signals at the GPS L1 frequency band to pass through. Therefore, a circularly polarized antenna operating at the GPS L1 frequency band can be realized by the first antenna including the main board 100, the annular conductor 200, the feeding unit 300, the first filter unit 601 and the first grounding unit 400.

In these implementations, the annular conductor 200, the feeding unit 300 and the second grounding unit are configured to generate circulating current signals at the second frequency band, and a second filter unit 620 is provided on an antenna circuit connecting the second grounding unit 500 to the annular conductor 200. The second filter unit 620 is configured to allow current signals at the second frequency band to pass through, and prevent current signals at the first frequency band from passing through. For instance, in the above examples, the second filter unit 620 is configured to prevent current signals at the GPS L1 frequency band from passing through and allow current signals at the GPS L5 frequency band to pass through. Therefore, a circularly polarized antenna operating at the GPS L5 frequency band can be realized by the second antenna including the main board 100, the annular conductor 200, the feeding unit 300, the second filter unit 620 and the second grounding unit 500.

In these implementations, since the generated first antenna and the second antenna are isolated from each other, the circularly polarized resonances generated by the first antenna and the second antenna do not affect each other, and dual-band circularly polarized signals that meet the requirements of use can be generated by using the same conductor. Simulation results will be provided to demonstrate the performance of the dual-band GPS circularly polarized antenna in the implementations of the present disclosure.

It can be understood that, the filter unit in an antenna circuit is configured to allow signals at the frequency band of the antenna circuit to pass through, and to block signals at the frequency bands other than the frequency band of the antenna circuit. The filter unit can be implemented with any filter circuit that can achieve this effect and is suitable for implementation, such as a band-stop filter, a band-pass filter, a high-pass filter or a low-pass filter. The present disclosure is not limited hereto.

The implementations with the band-stop filters are opposite to those with the band-pass filters. A band-stop filter refers to a filter that can block signals at certain frequency bands, while a band-pass filter refers to a filter that can allow signals at certain frequency bands to pass through. For instance, taking the first filter unit 610 shown in FIG. 2 as an example, in the case of utilizing a band stop filter, the first filter unit 610 may include a band stop filter blocking the GPS L5 band. In the case of utilizing a band-pass filter, the first filter unit 610 may include the band-pass filter allowing signals at the GPS L1 frequency band to pass through, while preventing signals at the GPS L5 frequency band from passing through.

The implementations of the high-pass filters are opposite to those of low-pass filters. A high-pass filter refers to a filter that allows signals at frequency bands above a frequency threshold to pass through, while a low-pass filter refers to a filter that allows signals at frequency bands below a frequency threshold to pass through. Referring again to the example shown in FIG. 2, the first filter unit 610 may include a high-pass filter allowing signals with a relatively high frequency band, i.e., the GPS L1 band, to pass through, while blocking signals with a relatively low frequency band, i.e., the GPS L5 band. The second filter unit 620 may include a low-pass filter, which allows signals with a relatively low frequency band, i.e., the GPS L5 band, to pass through, and blocks signals with a relatively high frequency band, i.e., the GPS L1 band.

In the following description, unless otherwise specified, the filter unit of the antenna is implemented with a band-stop filter as an example.

FIG. 3 shows the circuit structure of a conventional band-stop filter. FIG. 3 (a) shows a band-stop filter having two components, and FIG. 3 (b) shows a band-stop filter having three components.

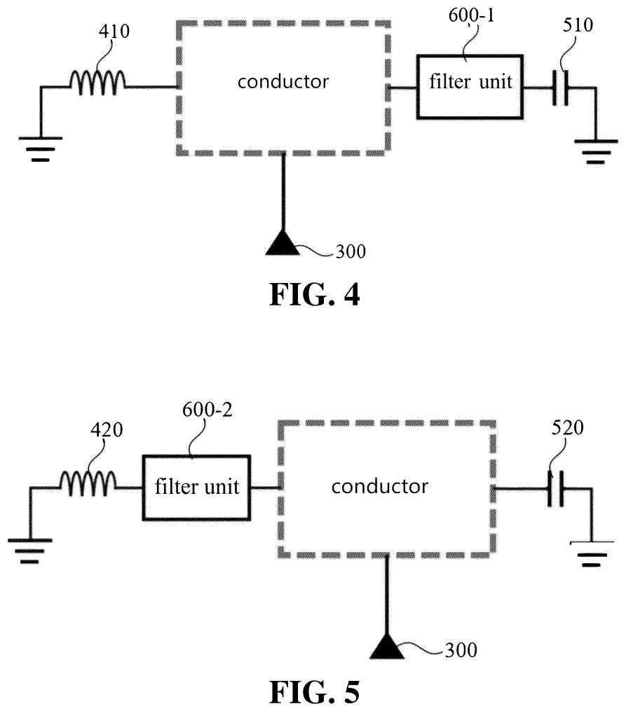

In some implementations, the filter unit includes a first filter unit 610 that blocks signals at the second communication band and a second filter unit 620 that blocks signals at the first communication band. That is, the filter unit is provided in both circuits of the first antenna and the second antenna, as shown in FIG. 2. In other implementations, the filter unit is provided in only one of the circuits of the first antenna and the second antenna, which is described below in conjunction with FIGS. 4 and 5.

Referring to the description about the circularly polarized antennas in the patent application CN112003006A, it can be seen that, frequency adjustment of the circularly polarized antenna can be achieved by simultaneously providing multiple capacitors and/or inductors. Any grounding unit in the implementations of the present disclosure is not limited to a single capacitor and/or inductor as shown in FIG. 2, but can also be implemented with multiple capacitors and/or inductors.

For instance, in the example shown in FIG. 4, a filter unit 600-1 is provided in the second antenna circuit, while no filter unit is provided in the first antenna circuit.

In the example shown in FIG. 4, the first grounding unit includes an inductor grounding terminal 410. The main board 100, the annular conductor 200, the feeding unit 300 and the inductor grounding terminal 410 form the first antenna operating at the first frequency band. The second grounding unit includes a capacitor grounding terminal 510 and the filter unit 600-1. The main board 100, the annular conductor 200, the feeding unit 300, the inductor grounding terminal 410 and the capacitor grounding terminal 510 form the second antenna operating at the second frequency band. That is, the inductor grounding terminal 410 contribute to both the first antenna and the second antenna. The inductor grounding terminal 410 can also be regarded as a part of the second grounding unit. In this case, the second grounding unit includes both the inductor grounding terminal 410 and the capacitor grounding terminal 510.

On the basis of the above-mentioned implementations of the first antenna and the second antenna, as shown in FIG. 4, only the second antenna circuit includes the filter unit 600-1, and the filter unit 600-1 is electrically connected between the capacitor grounding terminal 510 and the annular conductor 200.

In these implementations, the filter unit 600-1 is configured to prevent the current signals at the first frequency band from passing through, and allow the current signals at the second frequency band to pass through. Therefore, for the antenna system shown in FIG. 4, taking the realization of dual-band GPS circular polarization as an example, the circular polarization resonance at the GPS L1 frequency band can be achieved by connecting to the ground via the inductor grounding terminal 410. Meanwhile, the circular polarization resonance at the GPS L5 frequency band can be realized by connecting to the ground via the capacitor grounding terminal 510, or via the combination of the inductor grounding terminal and the capacitor grounding terminal 510. Due to the existence of the filter unit 600-1, the resonant frequency of the GPS L1 band does not affect the resonant frequency of the GPS L5 band, and the contribution of the inductor grounding terminal 410 to the circulating current signals at the first frequency band can be retained, both of the generated circulating currents can coexist in the electronic device, thereby realizing the dual-band GPS circularly polarized antenna.

In some other implementations, as shown in FIG. 5, a filter unit 600-2 is provided in the first antenna circuit, while no filter unit is provided in the second antenna circuit.

The second grounding unit includes a capacitor grounding terminal 520. The main board 100, the annular conductor 200, the feeding unit 300 and the capacitor grounding terminal 520 form the second antenna operating at the second frequency band. The first grounding unit includes the filter unit 660-2 and an inductor grounding terminal 420. The main board 100, the annular conductor 200, the feeding unit 300, the inductor grounding terminal 420 and the capacitor grounding terminal 520 form the first antenna operating at the first frequency band. That is, the capacitor grounding terminal 520 contribute to both the first antenna and the second antenna. The capacitor grounding terminal 520 may be also regarded as a part of the first grounding unit. In this case, the first grounding unit includes both the inductor grounding terminal 420 and the capacitor grounding terminal 520.

On the basis of the above-mentioned implementations of the first antenna and the second antenna, as shown in FIG. 5, only the first antenna circuit includes the filter unit 600-2, and the filter unit 600-2 is electronically connected between the inductor grounding terminal 420 and the annular conductor 200. In these implementations, the filter unit 600-2 is configured to prevent the current signals at the second frequency band from passing through, and allow the current signals at the first frequency band to pass through. Therefore, for the antenna system shown in FIG. 5, taking the realization of dual-band GPS circular polarization as an example, the circular polarization resonance at the GPS L5 frequency band can be realized by connecting to the ground via the capacitor grounding terminal 520, and the circular polarization resonance at the GPS L1 frequency band can be realized by connecting to the ground via the inductor grounding terminal 420, or via a combination of the inductor grounding terminal 420 and capacitor grounding terminal. Due to the existence of the filter unit 600-2, the resonant frequency at the GPS L5 band does not affect the resonant frequency at the GPS L1 band, the contribution of the capacitor grounding terminal 520 to the circulating current signals at the second frequency band can be retained, and both of the generated current signals can coexist in the electronic device, thereby realizing the dual-band GPS circularly polarized antenna.

As can be seen in FIGS. 2, 3, and 5, in the implementations of the present disclosure, a variety of manners can be used to provide the filter unit for the dual-band circularly polarized antenna system, thereby providing a higher degree of freedom and flexibility in antenna design.

Taking the antenna system shown in FIG. 4 as an example, the performance of the dual-band GPS circularly polarized antenna of the present disclosure is described below.

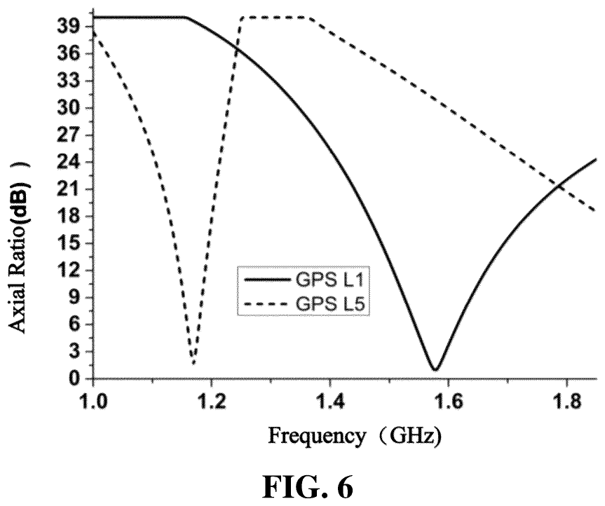

FIG. 6 illustrates curves of the variation of axial ratio with frequency for the separately or independently designed GPS L1 band and GPS L5 band in the antenna system of FIG. 4. As can be seen from FIG. 6, by providing the capacitor grounding terminal and the inductor grounding terminal, the resonant frequencies of the right-hand circularly polarized antenna are adjusted separately to the GPS L1 band with the inductor grounding terminal 410 and to the GPS L5 band with both the inductor grounding terminal 410 and the capacitor grounding terminal 510, and the antenna performance is quite desirable at both frequency bands.

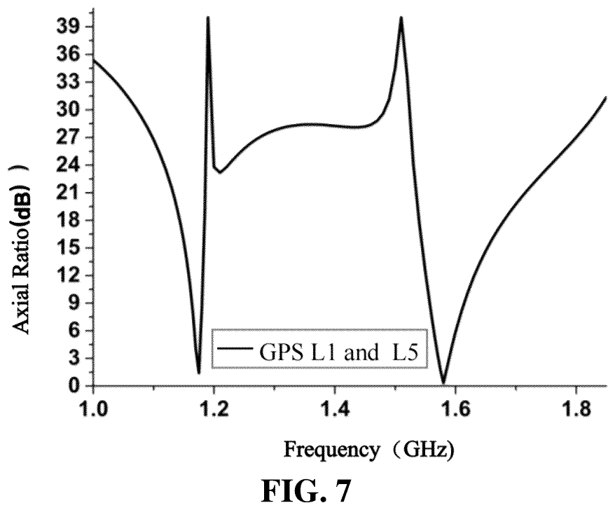

FIG. 7 shows curves of the change of the axial ratio with frequency for the antenna system of FIG. 4. It can be seen from FIG. 7 that, in the implementations of the present disclosure, the filter unit is utilized to isolate the first frequency band and the second frequency band, and the antenna system can simultaneously achieve dual-band GPS right-hand circular polarization at the GPS L1 frequency band and the GPS L5 frequency band, and has a desired antenna performance at both frequency bands, which can fully meet the design requirements of GPS right-hand circular polarization antenna. It should be noted that, due to the existence of the filter 600-1, in order to realize the GPS L5 band, the capacitance value of the capacitor grounding terminal needs to be adjusted compared with the case without the filter 600-1.

It can be seen from the above that, in the implementations of the present disclosure, a dual-band right-hand circularly polarized antenna for electronic devices can be realized, and the antenna performance can be improved. By using the disclosed solution to realize the dual-band GPS right-hand circularly polarized antenna, positioning accuracy and trajectory accuracy of the device can be greatly improved. Moreover, in the implementations of the present disclosure, the dual-band circularly polarized antenna is realized by using only one conductor, which simplifies the antenna structure, and is especially beneficial to the use in miniaturized wearable devices such as wrist-worn devices, and reduces the difficulty of antenna design.

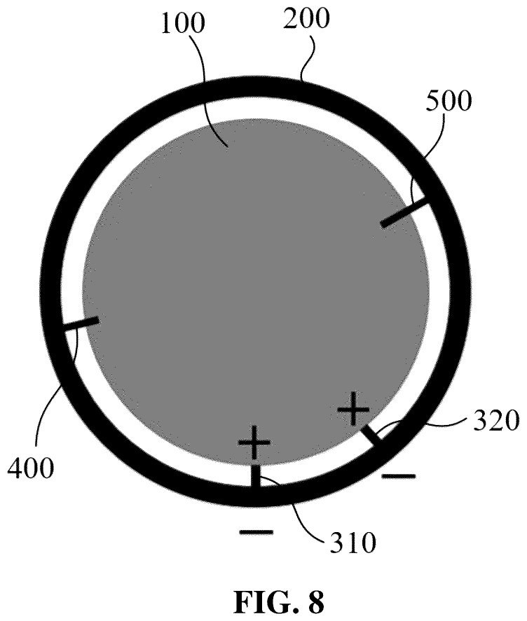

In the above implementations shown in FIGS. 2 to 5, the dual-band circularly polarized antenna system of the electronic device is implemented in a manner of a single feeding terminal. The feeding unit 300 includes only one feeding terminal, and the first antenna operating at the first frequency band and the second antenna operating at the second frequency band are realized with the same feeding terminal. In other implementations, the feeding unit 300 may include two feeding terminals, each feeding terminal contributes to the form of a circularly polarized antenna operating at a different frequency band, which will be described below with reference to FIG. 8.

As shown in FIG. 8, in some implementations, in the electronic device of the present disclosure, the feeding unit includes a first feeding terminal 310 and a second feeding terminal 320.

One end of the first feeding terminal 310 is connected to the annular conductor 200, and the other end of the first feeding terminal 310 is electrically connected to the radio frequency unit of the main board 100. In these implementations of the antenna system, the first antenna operating at the first frequency band includes the first feeding terminal 310, the first grounding unit 400, the main board 100 and the annular conductor 200.

One end of the second feeding terminal 320 is connected to the annular conductor 200, and the other end of the second feeding terminal 320 is electrically connected to the radio frequency unit of the main board 100. In these implementations of the antenna system, the second antenna operating at the second frequency band includes the second feeding terminal 320, the second grounding unit 500, the main board 100 and the annular conductor 200.

Based on the foregoing, it can be known that, in order to achieve dual-band circularly polarized signals, the filter unit is provided to isolate the first antenna and the second antenna. In the implementations of the present disclosure, since the current signals of the first feeding terminal 310 and the second feeding terminal 320 may interfere with each other, one or more additional filter units are needed to isolate the feeding terminals.

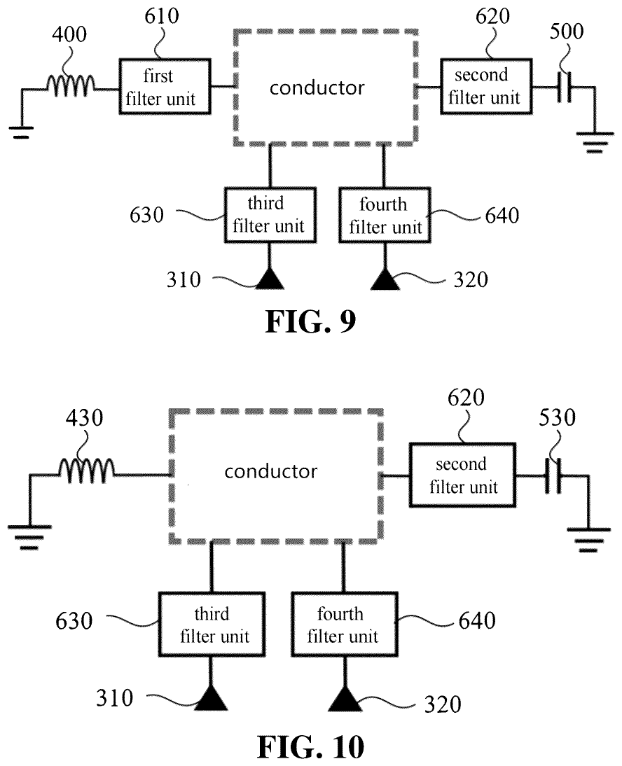

As shown in FIG. 9, in some implementations, still taking the implementations of dual-band GPS right-hand circular polarization as an example, the first grounding unit 400, the annular conductor 200, the first feeding terminal 310 and the main board 100 are configured to form the first antenna operating at the first frequency band. The second grounding unit 500, the annular conductor 200, the second feeding terminal 320 and the main board 100 are configured to form the second antenna operating at the second frequency band.

In the implementations of FIG. 9, the filter unit includes: a first filter unit 610 electrically connected between the first grounding unit 400 and the annular conductor 200, where the first filter unit 610 is configured to block signals at the GPS L5 band; a second filter unit 620 electrically connected between the second grounding unit 500 and the annular conductor 200, where the second filter unit 620 is configured to block signals at the GPS L1 band; a third filter unit 630 electrically connected between the first feeding terminal 310 and the annular conductor 200, where the third filter unit 630 is configured to block signals at the GPS L5 band; and a fourth filter unit 640 electrically connected between the second feeding terminal 320 and the annular conductor 200, where the fourth filter unit 640 is configured to block signals at the GPS L1 band.

Therefore, in the implementations of the present disclosure, the first filter unit 610 and the third filter unit 630 are configured to prevent the second frequency band (e.g., GPS L5 frequency band) from interfering with the first antenna. Meanwhile, the second filter unit 620 and the fourth filter unit 640 are configured to prevent the first frequency band (e.g., GPS L1 frequency band) from interfering with the second antenna. Therefore, the circularly polarized resonances generated by the first antenna and the second antenna do not affect each other, and dual-band circularly polarized signals that meet the needs of use can be generated, thereby realizing dual-band circular polarization for electronic devices with the same annular conductor.

Similar to the aforementioned implementations of a single feeding terminal shown in FIG. 4 and FIG. 5, in the implementations of two feeding terminals shown in FIG. 9, the filter unit may be provided either in both the circuits of the first antenna and the second antenna, or in only one of the first antenna circuit or the second antenna circuit.

As shown in FIG. 10, in some implementations, similar to the aforementioned implementations of FIG. 4, the first grounding unit includes an inductor grounding terminal 430. The main board 100, the annular conductor 200, the first feeding terminal 310 and the inductor grounding terminal 430 form the first antenna operating at the first frequency band. The second grounding unit includes the inductor grounding terminal 430 and a capacitor grounding terminal 530. The main board 100, the annular conductor 200, the second feeding terminal 320, the inductor grounding terminal 430 and the capacitor grounding terminal 530 form the second antenna operating at the second frequency band.

On the basis of the above-mentioned implementations of the first antenna and the second antenna, the second filter unit 620 and the fourth filter unit 640 are provided in the second antenna circuit, and both are configured to prevent the first frequency band from interfering with the second antenna. The third filter unit 630 is provided in the first antenna circuit, and is configured to prevent the second frequency band from interfering with the first antenna, so that the first frequency band and the second frequency band can coexist in the electronic device, realizing a dual-band circularly polarized antenna.

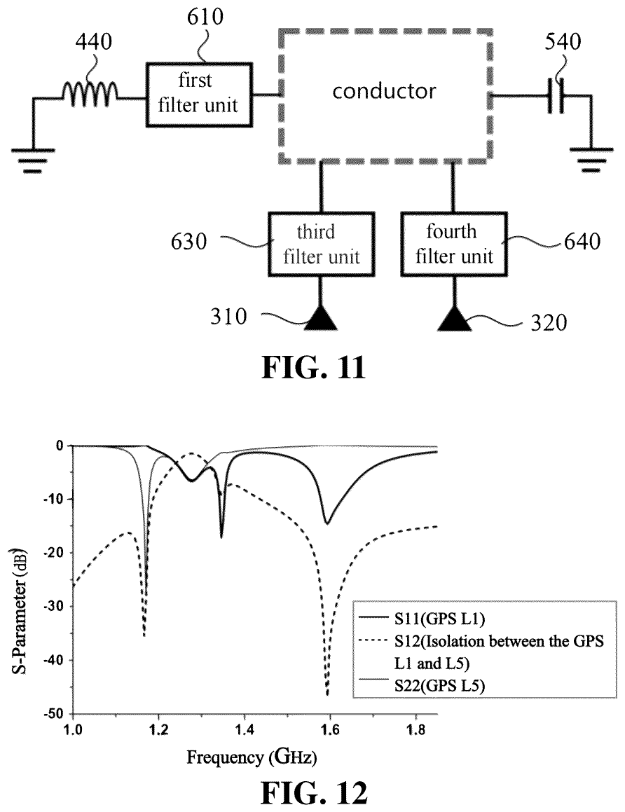

As shown in FIG. 11, in some implementations, similar to the aforementioned implementations shown in FIG. 5, the second grounding unit includes a capacitor grounding terminal 540, and the main board 100, the annular conductor 200, the second feeding terminal 320 and the capacitor grounding terminal 540 are configured to form the second antenna operating at the second frequency band. The first grounding unit includes an inductor grounding terminal 440 and the capacitor grounding terminal 540, and the main board 100, the annular conductor 200, the first feeding terminal 310, the inductor grounding terminal 440 and the capacitor grounding terminal 540 are configured to form the first antenna operating at the first frequency band.

On the basis of the above-mentioned implementations of the first antenna and the second antenna, the first filter unit 610 and the third filter unit 630 are provided in the first antenna circuit, and both are configured to prevent the second frequency band from interfering with the first antenna. The fourth filter unit 640 is provided in the second antenna circuit, and is configured to prevent the first frequency band from interfering with the second antenna, so that the first frequency band and the second frequency band can exist simultaneously in the electronic device, realizing a dual-band circularly polarized antenna.

The details not described in the above-mentioned implementations shown in FIG. 10 and FIG. 11 can be understood and fully implemented by those skilled in the art with reference to the aforementioned implementations, and will not be repeated herein.

The antenna performance of the GPS right-hand circularly polarized antenna of the present disclosure is described below by taking the antenna system in the implementations shown in FIG. 9 as an example.

FIG. 12 illustrates curves of S-parameter (i.e., return loss) of the first antenna and the second antenna in the antenna system shown in FIG. 9. It can be seen from FIG. 12 that, in the implementations of the antenna system of the present disclosure, there is a desirable antenna isolation between the first antenna operating at the GPS L1 frequency band and the second antenna operating at the GPS L5 frequency band, which can fully satisfy requirements for dual-band GPS antennas.

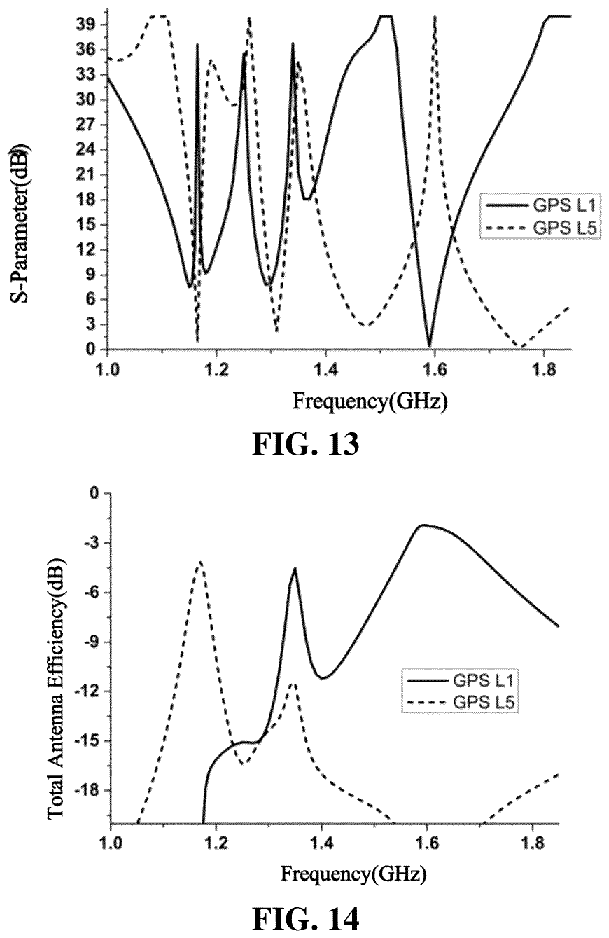

FIG. 13 shows curves of the axial ratio versus frequency for the antenna system shown in FIG. 9, and FIG. 14 shows curves of total antenna efficiency versus frequency for the antenna system shown in FIG. 9. It can be seen from FIG. 13 and FIG. 14 that, the antenna system of the present disclosure has a desired axial ratio and antenna efficiency at both the GPS L1 frequency band and the GPS L5 frequency band, and can meet the design requirements for dual-band GPS right-hand circularly polarized antennas.

As can be seen from the above, in the implementations of the present disclosure, for the dual-band circularly polarized antenna system, a variety of manners can be used to implement the filter unit and the feeding unit, thereby having a higher degree of freedom and flexibility in antenna design. In some implementations, as an alternative of the above-mentioned inductor grounding terminal, a capacitor grounding terminal or other types of tuning components may be included in the first grounding unit, or both an inductor grounding terminal and a capacitor grounding terminal are included in the first grounding unit. Similarly, in some implementations, as an alternative of the above-mentioned capacitor grounding terminal, an inductor grounding terminal or other types of tuning components may be included in the second grounding unit, or both an inductor grounding terminal and a capacitor grounding terminal are included in the second grounding unit, which is not limited in the present disclosure.

It is worth noting that, in the above-mentioned implementations of the present disclosure, the two frequency bands of the antenna obtained by the same annular conductor are both circularly polarized.

In some other implementations of the present disclosure, a dual-band antenna with circular polarization and linear polarization may be realized with the same annular conductor. In this case, the circularly polarized antenna utilizes the entire annular conductor, while only a part of the annular conductor is used for the linearly polarized antenna.

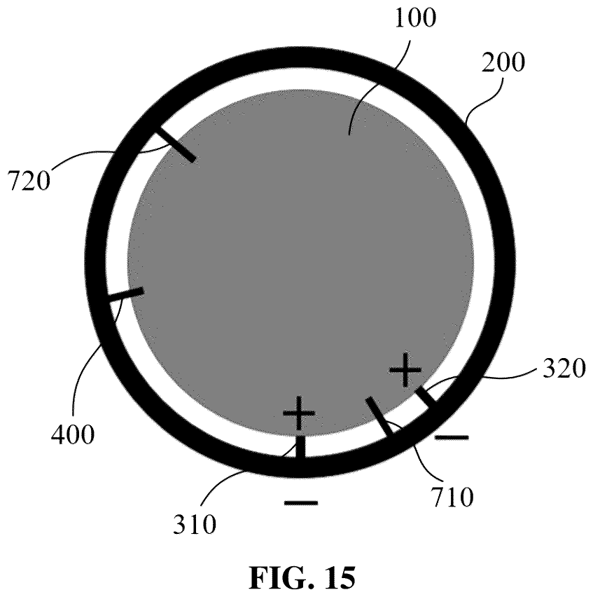

In some implementations, in the electronic device of the present disclosure, an example structure of the dual-band antenna system is shown in FIG. 15. In these implementations, the first feeding terminal 310, the first grounding unit 400, the main board 100 and the annular conductor 200 form the first antenna operating at the first frequency band. Based on the above descriptions, the resonance generated by the first antenna is in the form of circular polarization.

In the implementations shown in FIG. 15, the second antenna operating at the second frequency is no longer a circularly polarized antenna, but a linearly polarized antenna. Specifically, in these implementations, the second antenna includes a second feeding terminal 320, a first grounding terminal 710 and a second grounding terminal 720, and only a part of the annular conductor 200 between the first grounding terminal 710 and the second grounding terminal 720 is served as the radiator of the linearly polarized antenna. As shown in FIG. 15, the first grounding terminal 710 and the second grounding terminal 720 are provided on the two sides of the second feeding terminal 320 on the annular conductor 200, and the second feeding terminal 320 may be located near to one of the first grounding terminal 710 and the second grounding terminal 720. For example, a distance between the second feeding terminal 320 and one of the first grounding terminal 710 and the second grounding terminal 720 is less than a certain value, so as to realize better antenna matching.

By applying feeding and grounding means to the annular gap between the main board 100 and the annular conductor 200, a linearly polarized resonant wave is generated, and the half of the wavelength of the resonant waves is equal to the effective arc length of an arc-shaped gap between the first grounding terminal 710 and the second grounding terminal 720, that is, the linearly polarized antenna is a λ/2 antenna. Those skilled in the art would understand various possible implementations the linearly polarized antennas based on the above descriptions, which will not be further elaborated in the present disclosure.

On the basis of the above-mentioned implementations where the first antenna is in the form of circular polarization and the second antenna is in the form of linear polarization, in order to prevent the resonant frequencies of the two antennas from interfering with each other, the filter unit is also needed in the antenna system.

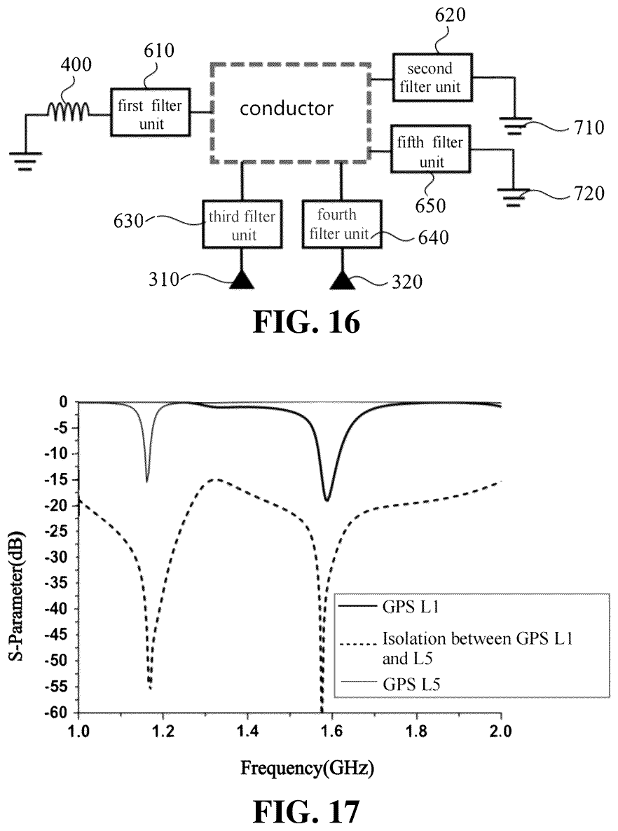

As shown in FIG. 16, a first filter unit 610 is provided in the circuit connecting the first grounding unit 400 to the annular conductor 200. A third filter unit 630 is provided in the circuit connecting the first feeding terminal 310 to the annular conductor 200. A fourth filter unit 640 is provided in the circuit connecting the second feeding terminal 320 to the annular conductor 200. A second filter unit 620 and a fifth filter unit 650 are provided in the circuits connecting the first grounding terminal 710 and the second grounding terminal 720 to the annular conductor 200, respectively.

In these implementations, the first filter unit 610 and the third filter unit 630 both are configured to allow signals at the first frequency band (e.g., GPS L1 frequency band) to pass through, while preventing signals at the second frequency band (e.g., GPS L5 frequency band) from passing through. The second filter unit 620, the fourth filter unit 640 and the fifth filter unit 650 are all configured to allow signals at the second frequency band (e.g., GPS L5 frequency band) to pass through, while preventing signals at the first frequency band (e.g., GPS L1 frequency band) from passing through. Thus, the first frequency band in the form of circular polarization generated by the first antenna and the second frequency band in the form of linear polarization generated by the second antenna do not interfere with each other, thereby realizing a dual-band antenna system in the form of circular polarization and linear polarization.

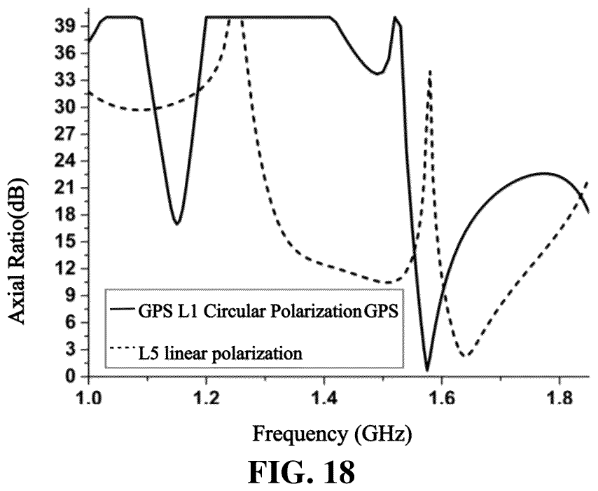

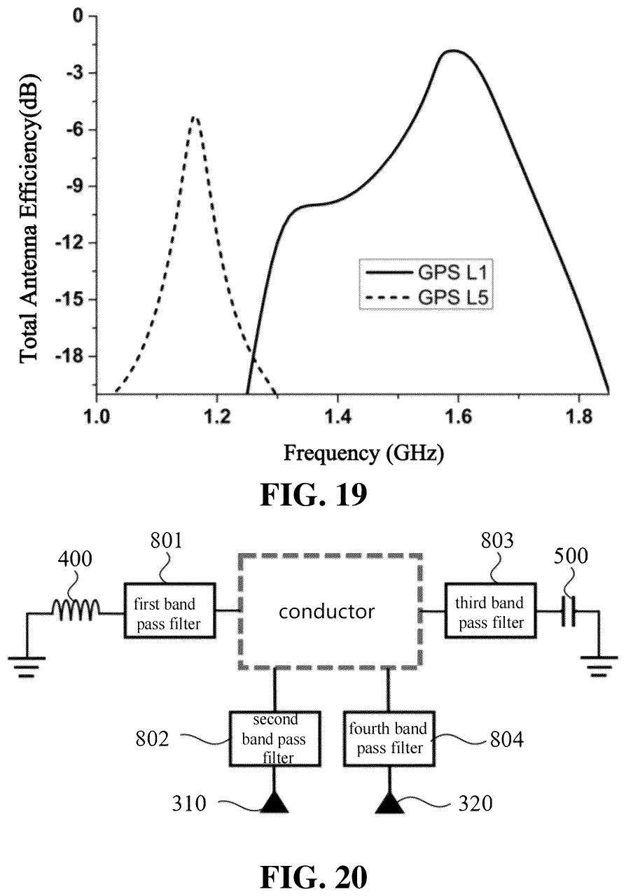

FIG. 17 illustrates curves of the S-parameter of the antenna system in FIG. 16. FIG. 18 illustrates curves of the variation of the axial ratio of the GPS L1 band in the implementations of FIG. 16 with frequency. FIG. 19 illustrates the change of total antenna efficiency of the GPS L1 and GPS L5 frequency bands in the implementations of FIG. 16 with frequency. Referring to FIGS. 17 to 19, it can be seen that, in the implementations of the antenna system of the present disclosure, there is a desirable isolation between the GPS L1 and GPS L5 antennas, and the antenna efficiency of both the GPS L1 and GPS L5 bands can meet the design requirements of dual-band GPS. A desirable axial ratio is achieved for the circularly polarized GPS L1 antenna frequency band, which demonstrates that the dual-band antenna system in the form of circular polarization and linear polarization is completely feasible.

It can be seen from the above that, in the implementations of the present disclosure, a dual-band right-hand circularly polarized antenna for electronic devices can be realized, and the antenna performance can be improved. By using the disclosed solution to realize the dual-band GPS right-hand circularly polarized antenna, positioning accuracy and trajectory accuracy of the device can be greatly improved. Moreover, in the implementations of the present disclosure, the dual-band circularly polarized antenna is realized by using only one annular conductor, which simplifies the antenna structure, and is especially beneficial to the use of miniaturized wearable devices such as wrist-worn devices, and reduces the difficulty of antenna design. Furthermore, in the implementations of the present disclosure, various designs of dual-band antennas can be implemented, thereby improving design diversity and freedom.

It is worth noting that, the above-mentioned implementations are intended to be illustrative illustrations of the present disclosure, and do not limit the implementations of the present disclosure. For instance, in the above implementations, the first grounding unit and the second grounding unit both are implemented with a grounding terminal, such as a capacitor grounding terminal or an inductor grounding terminal. Based on the patent application CN112003006A, it can be seen that a grounding terminal may be equivalent to a combination of multiple grounding terminals. Therefore, in the implementations of the present disclosure, the first grounding unit may include multiple grounding terminals, and the second grounding unit may similarly include multiple grounding terminals, which is not limited in the present disclosure.

The annular conductor in the present disclosure may refer to a closed loop structure, and may have various possible shapes, such as circular, square, rectangular, elliptical, irregular and so on.

In some implementations, the solution of the present disclosure will be further described by taking the dual-band GPS circularly polarized antenna provided in a smart watch as an example.

In the implementations of the present disclosure, the first frequency band of the dual-band GPS circularly polarized antenna system includes the GPS L1 frequency band centered at around 1.575 GHz, and the second frequency band includes the GPS L5 frequency band centered at 1.176 GHz.

As shown in FIG. 1, the annular conductor 200 may be realized by the metallic middle frame of the smart watch. It can be understood that, the annular conductor 200 is not limited to the metallic middle frame, and any other annular conductive structure can be used as the annular conductor 200 in the implementations of the present disclosure, such as a metallic bezel located on the front side of the smart watch, or a decorative metallic frame located on the back cover of the smart watch, which is not limited in the present disclosure.

The main board 100 may be a PCB of the smart watch, which is positioned inside the housing of the smart watch. The housing of the smart watch may include the above-mentioned metallic middle frame and a non-metallic back cover 900. The back cover 900 is attached to the bottom side of the metallic middle frame. Meanwhile, the smart watch also includes the screen assembly 800, attached to the top side of the metallic middle frame.

The smart watch may further include other electrical structures that implement various functions, such as batteries, vibration motors, speakers, cameras, etc., which will not be described in detail in the present disclosure.

It can be understood that, the frequency bands of the GPS L1 and GPS L5 are different from each other. Therefore, in the case where the same annular conductor 200 is utilized to realize the dual-band antennas with two different frequency bands, the following three optional implementations may be used.

In the first possible implementation, the effective perimeter of the annular conductor is greater than the wavelength corresponding to the center frequency of the GPS L5 band.

Since the wavelength of GPS L5 is greater than the wavelength of GPS L1, the effective perimeter of the annular conductor is greater than both the wavelengths of GPS L1 antenna and GPS L5 antenna. In this case, since the original effective circumference of the annular conductor 200 is relatively large, the original resonant frequency of the annular conductor 200 is lower than the required resonant frequency. Therefore, an inductor grounding terminal may be utilized for both GPS L1 antenna and GPS L5 antenna, so as to reduce the effective perimeter of the annular conductor and increase the resonant frequencies.

For instance, in an example, the original resonant frequency of the annular conductor 200 is 1.12 GHz. The first grounding unit may include an inductor grounding terminal. By adjusting the inductance value and/or position of the inductor grounding terminal, the resonant frequency of the first antenna can be adjusted to 1.176 GHz. The second grounding unit may include an inductor grounding terminal. By adjusting the inductance value and/or position of the inductor grounding terminal, the resonant frequency of the second antenna can be adjusted to 1.575 GHz. Meanwhile, referring to the above implementations, the filter unit is provided to implement the dual-band GPS circularly polarized antenna.

In the second possible implementation, the effective perimeter of the annular conductor is less than the wavelength corresponding to the center frequency of the GPS L1 band.

Since the wavelength of GPS L5 is greater than that of GPS L1, the effective perimeter of the annular conductor 200 is smaller than the wavelengths of both GPS L1 antenna and GPS L5 antenna. In this case, since the original effective perimeter of the annular conductor 200 is relatively small, the original resonant frequency of the annular conductor 200 is higher than the required resonant frequency. Therefore, for both GPS L1 antenna and GPS L5 antenna, a capacitor grounding terminal may be provided to increase the effective perimeter of the annular conductor and reduce the resonant frequencies.

For instance, in an example, the original resonant frequency of the annular conductor 200 is 1.67 GHz. The first grounding unit includes a capacitor grounding terminal. By adjusting the capacitance value and/or position of the capacitor grounding terminal, the resonant frequency of the first antenna can be adjusted to 1.575 GHz. The second grounding unit includes a capacitor grounding terminal. By adjusting the capacitance value and/or position of the capacitor grounding terminal, the resonant frequency of the second antenna can be adjusted to 1.176 GHz. Meanwhile, referring to the above implementations, the filter unit is provided to implement the dual-band GPS circularly polarized antenna.

In the third possible implementation, the effective perimeter of the annular conductor is less than the wavelength corresponding to the center frequency of the GPS L5 band and greater than the wavelength corresponding to the center frequency of the GPS L1 band.

In this case, the effective perimeter of the annular conductor 200 is between the two wavelengths of the dual-band GPS antenna. Therefore, an inductive grounding terminal may be provided in the first grounding unit to reduce the effective perimeter of the annular conductor and enlarge its resonant frequency. For the second grounding unit, a capacitor grounding terminal may be provided to increase the effective perimeter of the annular conductor and reduce its resonant frequency.

For instance, in an example, the original resonant frequency of the annular conductor 200 is 1.46 GHz. The first grounding unit may include an inductor grounding terminal. By adjusting the inductance value and/or position of the inductor grounding terminal, the resonant frequency of the first antenna can be adjusted to 1.575 GHz. The second grounding unit may include a capacitor grounding terminal. By adjusting the capacitance value and/or position of the capacitor grounding terminal, the resonant frequency of the second antenna can be adjusted to 1.176 GHz. Meanwhile, referring to the above implementations, the filter unit is provided to implement the dual-band GPS circularly polarized antenna.

The GPS circularly polarized antenna system described in the implementations of the present disclosure can be realized in all of the above three implementations. Furthermore, considering that the original resonant frequency of the annular conductor in the third possible implementation is closer to both the required operating frequencies of the dual-band GPS antenna, the antenna design is therefore easier to be implemented. Therefore, the implementations described in the present disclosure are made by taking the third possible implementation as an example.

In addition, it is worth noting that, in the above example implementations, the filter unit is implemented by a band-stop filter. In other implementations, the filter unit may be implemented by a bandpass filter, a high-pass filter, a low-pass filter or the like.

In some implementations, as shown in FIG. 20, the difference with the previous implementations is that the filter units provided in the first antenna circuit and the second antenna circuit are both band-pass filters. In these implementations, a first band-pass filter 801 and a second band-pass filter 802 are both configured to allow signals at the first frequency band to pass through and prevent signals at the second frequency band from passing through. A third band-pass filter 803 and a fourth band-pass filter 804 both are configured to allow signals at the second frequency band to pass through and prevent signals at the first frequency band from passing through. The working principle of the antenna system is similar as that of the above-mentioned implementations, and the dual-band circularly polarized antenna system can also be implemented.

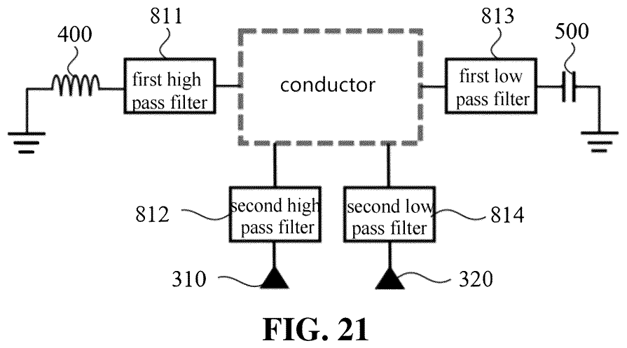

In some other implementations, such as shown in FIG. 21, the difference from the previous implementations is that the filter unit provided in the first antenna circuit is a high-pass filter unit, and the filter unit provided in the second antenna circuit is a low-pass filter unit. In these implementations, since the center frequency of the first frequency band, e.g., GPS L1 band, is greater than the center frequency of the second frequency band, e.g., GPS L5 band, a first high-pass filter 811 and a second high-pass filter 812 may be configured to allow signals at the first frequency band with a higher frequency to pass through, but prevent signals at the second frequency band with a lower frequency from passing through. Similarly, a first low-pass filter 813 and a second low-pass filter 814 may be configured to allow signals at the second frequency band with a lower frequency to pass through, but to prevent signals at the first frequency band with a higher frequency from passing through. The working principle of the antenna system is similar as that of the above-mentioned implementations, and a dual-band circularly polarized antenna system can also be implemented.

It can be seen from the above that, in the implementations of the present disclosure, a dual-band circularly polarized antenna for electronic devices can be realized and the antenna performance can be improved. By applying the disclosed solution to realize a dual-band GPS circularly polarized antenna, the positioning accuracy and trajectory accuracy of the device can be greatly improved. Moreover, in the implementations of the present disclosure, a dual-band circularly polarized antenna can be realized by using only one annular conductor, which simplifies the antenna structure, and is especially beneficial to its use in miniaturized wearable devices such as wrist-worn devices, and reduces the difficulty of antenna design. Furthermore, the implementations of the present disclosure can realize various kinds of dual-band antenna, improving design diversity and freedom.

The above-mentioned implementations are only examples for the purpose of explanation, and do not limit other possible implementations. For those of ordinary skill in the art, other different kinds of changes or modifications can be made based on the above description. It is not necessary or possible to exhaust all of the implementations, and various obvious changes or modifications derived therefrom are within the protection scope of the present disclosure.

What is claimed is:

1. An electronic device, comprising:
an annular conductor, electrically coupled to a main board;
a dual-band grounding unit, comprising a first grounding unit and a second grounding unit, wherein the first grounding unit, the main board and the conductor form a circularly polarized antenna operating at a first frequency band, and the second grounding unit, the main board and the annular conductor form a circularly polarized antenna operating at the second frequency band; and
a filter unit, provided in at least one of a circuit connecting the first grounding unit to the annular conductor or a circuit connecting the second grounding unit to the annular conductor, wherein the filter unit is configured to filter out signals at frequency bands other than a frequency band of the circuit where the filter unit is located.

2. The electronic device according to claim 1, further comprising:
a feeding unit, comprising a feeding terminal, wherein
one end of the feeding terminal is connected to the annular conductor, and the other end of the feeding terminal is electrically connected to a radio frequency unit of the main board;
the feeding terminal, the annular conductor and the first grounding unit form a circularly polarized antenna operating at the first frequency band, and
the feeding terminal, the annular conductor and the second grounding unit form a circularly polarized antenna operating at the second frequency band.

3. The electronic device according to claim 1, further comprising:
a feeding unit, comprising a first feeding terminal and a second feeding terminal, wherein
one end of the first feeding terminal is connected to the annular conductor, the other end of the first feeding terminal is electrically connected to a radio frequency unit of the main board, and the first feeding terminal, the annular conductor and the first grounding unit form a circularly polarized antenna operating at the first frequency band; and
one end of the second feeding terminal is connected to the annular conductor, the other end of the second feeding terminal is electrically connected to the radio frequency unit of the main board, and the second feeding terminal, the annular conductor and the second grounding unit form a circularly polarized antenna operating at the second frequency band.

4. The electronic device according to claim 3,
wherein the filter unit comprises a first filter unit provided in the circuit connecting the first feeding terminal to the annular conductor, and the filter unit comprises a second filter unit provided in the circuit connecting the second feeding terminal to the annular conductor, the first filter unit being configured to filter out signals at the second frequency band, and the second filter unit being configured to filter out signals at the first frequency band.

5. The electronic device according to claim 1, wherein:
a physical perimeter of the annular conductor is between a first wavelength corresponding to a center frequency of the first frequency band and a second wavelength corresponding to a center frequency of the second frequency band.

6. The electronic device according to claim 1, wherein the first grounding unit is configured to adjust a resonance frequency band of the antenna formed by the first grounding unit and the annular conductor to the first frequency band, and the second grounding unit is configured to adjust a resonance frequency band of the antenna formed by the second grounding unit and the annular conductor to the second frequency band.

7. The electronic device according to claim 1, wherein
the first grounding unit comprises a grounding terminal and at least one inductor, one end of the first grounding terminal being connected to the annular conductor, and the other end of the first grounding terminal being electrically connected to the main board through at least one inductor.

8. The electronic device according to claim 1, wherein
the second grounding unit comprises a grounding terminal and at least one capacitor, one end of the second grounding terminal being connected to the annular conductor, and the other end of the second grounding terminal being electrically connected to the main board through the at least one capacitor.

9. The electronic device according to claim 1, wherein
the first frequency band comprises a GPS L1 band, and the second frequency band comprises a GPS L5 band.

10. The electronic device according to claim 1, wherein the electronic device is a wrist-worn device.

11. The electronic device according to claim 1, wherein the annular conductor comprises a metallic middle frame; and
the electronic device further comprises:
a back cover, attached to one side of the metallic middle frame; and
a display component, attached to the other side of the metallic middle frame.

12. The electronic device according to claim 1, wherein the electronic device further comprises a housing, the housing comprising a non-metallic middle frame and a back cover provided on one side of the middle frame; and
the annular conductor comprises a metallic bezel, provided on the other side of the middle frame.

13. A dual-band antenna assembly for an electronic device, comprising:
a first antenna operating at a first frequency band, comprising an annular conductor, a first grounding unit and a main board; and
a second antenna operating at a second frequency band, comprising at least a part of the annular conductor, a second grounding unit and the main board;
wherein at least one of the first antenna or the second antenna further comprises a filter unit, the filter unit in the first antenna is configured to filter out signals at the second frequency band, and the filter unit in the second antenna is configured to filter out signals at the first frequency band; and
wherein the first antenna is circularly polarized.

14. The dual-band antenna assembly according to claim 13, wherein the second antenna is circularly polarized, and the annular conductor as a whole is served as a radiator of both the first antenna and the second antenna.

15. The dual-band antenna assembly according to claim 13, wherein the second grounding unit comprises at least two grounding terminals, and the second antenna is linearly polarized with a part of the annular conductor between the at least two grounding terminals as a radiator.

16. The dual-band antenna assembly according to claim 13, further comprising:
a bezel, a middle frame and a back cover, wherein one side of the middle frame is connected to the bezel, the other side of the middle frame is connected to the back cover, and the annular conductor comprises one of the middle frame or the bezel.

17. The dual-band antenna assembly according to claim 13, further comprising:
a shared feeding terminal, wherein one end of the shared feeding terminal is connected to the annular conductor, and the other end of the shared feeding terminal is electrically coupled to a radio frequency unit of the main board.

18. The dual-band antenna assembly according to claim 13,
wherein the first antenna further comprises a first feeding terminal and an additional filter unit, one end of the first feeding terminal being connected to the annular conductor, and the other end of the first feeding terminal being electrically connected to a radio frequency unit of the main board via the additional filter unit; and
wherein the second antenna further comprises a second feeding terminal and an additional filter unit, one end of the second feeding terminal being connected to the annular conductor, and the other end of the second feeding terminal being electrically connected to the radio frequency unit of the main board via the additional filter unit.

19. The dual-band antenna assembly according to claim 13, wherein the first grounding unit comprises a tuning component, and the tuning component comprises at least one of an inductor or an capacitor.

20. The dual-band antenna assembly according to claim 13, wherein a physical perimeter of the annular conductor is between a first wavelength corresponding to the first frequency band and a second wavelength corresponding to the second frequency band.
